(19) United States
(12) Patent Application Publication
(10) Pub. No.: US 2024/0006089 A1
(43) Pub. Date: Jan. 4, 2024

(54) BLOCKING DEVICE FOR STOPPING SOLID BODIES THAT HAVE BEEN IRRADIATED OR THAT ARE TO BE IRRADIATED

(71) Applicant: EQE GMBH, Schöftland (CH)

(72) Inventors: Thomas MAIBACH, Schöftland (CH); Pascal BACHMANN, Schöftland (CH); Alexander MENGES, Schöftland (CH); Sebastian ZIEGLER, Schöftland (CH); Felix BÖHLER, Schöftland (CH)

(73) Assignee: eqe AG, Olten (CH)

(21) Appl. No.: 18/037,933

(22) PCT Filed: Nov. 2, 2021
(86) PCT No.: PCT/EP2021/080328

§ 371 Date: May 19, 2023

(30) Foreign Application Priority Data
Nov. 20, 2020 (EP) 20208937.1

(51) Int. Cl. G21C 19/28; G21C 17/108; G01T 3/00

(52) U.S. Cl. CPC G21C 19/28; G21C 17/108; G01T 3/00

(57) ABSTRACT

The invention relates to a blocking device (5) for stopping solid bodies that have been irradiated or that are to be irradiated in a conduit system (2) which is used to transport the solid bodies by means of a propelling fluid into and out from a nuclear reactor (1). The blocking device has at least one main body (52) with a continuous channel (521) for the solid bodies and an actuator (58), which is arranged inside the main body (52) and which is adjustable relative to the main body (52) between an open position and a closed position in such a way that the channel (521) for the solid bodies is open in the open position and is closed in the closed position. The actuator (58) can be brought from the open position into the closed position and from the closed position into the open position by being displaced relative to the at least one main body (52). The blocking device can be used in particular as part of an aeroball measurement system (3) or as part of a nuclide activation system (4).

### TECHNICAL FIELD

The invention relates to a blocking device for stopping solid bodies that have been irradiated or that are to be irradiated in a conduit system which is used to transport the solid bodies by means of a propellant fluid, in particular a propellant gas, into and out of a nuclear reactor. The blocking device is usable in particular for stopping balls of an aeroball measurement system, which is used to measure the neutron flux distribution in a nuclear reactor. Alternatively, the blocking device is usable for stopping targets of a nuclide activation system, which is used to irradiate the targets in a nuclear reactor.

### PRIOR ART

Aeroball measurement systems, which are often also designated in German as “Kugelschussmesssysteme”, are known for measuring the neutron flux distribution in a nuclear reactor in, for example, a nuclear power plant. The flux distribution determined by means of an aeroball measurement system is used, among other things, to regularly recalibrate the continuously measuring neutron measuring systems (which are equipped with fewer measuring points, however) or to validate their signals.

An aeroball measurement system typically comprises multiple pipes, which protrude into the reactor core at multiple points in parallel to the fuel rods in the vertical direction. For the measurement, vanadium-containing steel balls are transported via a conduit system and with the aid of a propellant gas into the pipes, where they remain for several minutes arrayed along the fuel rods and are activated by the neutrons. With the aid of the propellant gas, the balls are then transported via the conduit system to a measuring table outside the reactor. The activity of the steel balls is measured there using radiation detectors. Since the balls are always arranged in succession both in the pipes in the reactor core and in the conduit system and on the measuring table, a position in the reactor core can be assigned to each of the individual balls and the neutron flux at the respective points in the reactor core can be concluded from the radiation activity of the balls. The conduit system usually comprises a plurality of control valves to distribute the balls on the respective pipes in the reactor core, also called instrumentation fingers. Similarly thereto, control valves can be used to distribute the balls on various positions of the measuring table.

During the transport through the conduit system, the balls each receive a high level of kinetic energy and have to be stopped before they reach the measurement position, for example, or where no measurement is being carried out and the balls are brought into a parking position. In addition, emergency closing blocks are used, for example, to disconnect a conduit system section close to the reactor from a conduit system section far from the reactor, for example, upon occurrence of a leak in an instrumentation finger. Rotation valves and ball valves are used to stop the balls or close the conduits in the prior art.

The existing aeroball measurement system can additionally be used to irradiate nuclides. The radionuclides thus resulting are used in medicine, or also in other fields of technology. For example, using radionuclides in nuclear medicine for irradiating prostate cancer is known. So-called nuclide activation targets can be introduced into the instrumentation fingers of an aeroball measurement system, when no measurement is being carried out, to generate the radionuclides. The targets, which can be spherical, oval, or cylindrical or can have any other shape, are for this purpose shot similarly to the measuring balls by means of a propellant gas through the conduit system of the aeroball measurement system into the instrumentation fingers arranged in the reactor core. The measuring balls are located here in a parking position. When a measurement is necessary, the targets have to be removed from the pipes in the reactor core and in turn transported via the conduit system into a parking position.

Just like the measuring balls, the targets also each receive a high level of kinetic energy during the transport through the conduit system and each have to be able to be stopped upon or before reaching the parking position or upon the occurrence of an emergency. It also has to be possible to remove the targets from the system after sufficient irradiation time and replace them with new targets to be irradiated. Stopping procedures are also necessary for this purpose to decelerate the targets before transferring them into a removal container. Rotation valves and ball valves are also used for stopping the targets in the prior art, just as for stopping the measuring balls.

Ball valves connected to one another in a rotationally fixed manner for stopping and distributing measuring balls and targets are known from DE 10 2017 125 606 A1. The ball valves are jointly adjustable with the aid of a single driveshaft.

The space is extremely limited in nuclear power plants, in particular in the shielded inner area. The arrangement of the rotatable valve bodies necessary with rotation valves and ball valves and the drive one on top of another along the axis of rotation extending perpendicularly to the conduits is therefore disadvantageous with regard to the space requirement. Little space is usually allocated in particular to the nuclide activation system, which is not necessary for the operation of the nuclear power plant, or the nuclide activation system is retrofitted and has to be housed within the available limited space. There is therefore a need for designing and arranging the components of aeroball measurement systems and in particular the components of nuclide activation systems in as space-saving a manner as possible. In addition, the production of rotation valves and ball valves is comparatively complex due to the many rounded surfaces. Depending on whether it is an emergency closing device which is also supposed to be able to suppress the passage of the propellant gas or whether it is a blocking device which does stop the balls but is still to be permeable to the propellant gas, different demands arise for the sealing or permeability in the closed position. These requirements are often achievable with difficulty or with significant expenditure in the case of rotation valves and ball valves.

### SUMMARY OF THE INVENTION

It is thus an object of the present invention to specify a blocking device for stopping solid bodies that have been irradiated or are to be irradiated in a conduit system, which is easily producible and space-saving. A blocking device as specified in claim 1 is proposed to achieve this object. In addition, two different uses of such a blocking device are specified in claims 12 and 13. Advantageous embodiments are specified in the dependent claims.

The present invention thus provides a blocking device for stopping solid bodies that have been irradiated or are to be irradiated in a conduit system, which is used to transport the solid bodies by means of a propellant fluid, in particular a propellant gas, into and out of a nuclear reactor and in particular can form a part of an aeroball measurement system. The blocking device comprises
at least one main body having a continuous channel for the solid bodies, and
an actuator arranged inside the main body, which is adjustable relative to the main body between an open position and a closed position in such a way that the channel for the solid bodies is passable in the open position and is closed in the closed position.

The actuator is movable by means of displacement, i.e., by means of a translational movement, relative to the at least one main body from the open position into the closed position and from the closed position into the open position.

In that the actuator is displaced to open and close the blocking device and not rotated as in the prior art, diverse possibilities result for not only producing the blocking device more simply, but also designing and arranging it in a particularly space-saving manner. In particular, rounded surfaces are no longer required.

The continuous channel present in each main body is therefore closed, i.e., blocked to the solid bodies, or opened in each case by the displacement of the actuator relative to the at least one main body. In one particularly preferred embodiment, the actuator extends into the main body or bodies in such a way that it interrupts the channel or channels in its closed position or releases them in the open position. That is to say, the channel or the channels each extend on both sides of the actuator and depending on the position the actuator forms a blocking bar or establishes a connection between the two channel parts present on both sides. The actuator preferably has corresponding connecting channels for this purpose. A channel in the context of this document means a conduit completely enclosed by material, that is to say the channel forms a completely enclosed opening for the passage of the solid bodies.

The solid bodies which have been irradiated or are to be irradiated can in particular be used as part of an aeroball measurement system for measuring the neutron flux distribution in the nuclear reactor. In this case, the solid bodies are preferably produced from vanadium-containing steel. The conduit system then forms a part of an aeroball measurement system (also known in German as “Kugelschussmesssystem”) together with the balls.

The solid bodies which have been irradiated or are to be irradiated can, however, also be nuclide activation targets, which are irradiated in the reactor core for medical purposes, for example. The conduit system then forms a part of a nuclide activation system, which is preferably provided and used in combination with an aeroball measurement system. The nuclide activation system can in particular be retrofitted subsequently in addition to an aeroball measurement system.

The solid bodies are preferably balls. In principle, however, they can have any other arbitrary shapes, wherein in particular a cylindrical, pellet-like shape is suitable.

The solid bodies typically have an external diameter from 1 mm to 2 mm. The conduits of the conduit system accordingly also have an internal diameter of 1 mm to 2 mm. The internal diameter of the conduits and of the continuous channel of the at least one main body can be slightly larger than the external diameter of the solid bodies, but not more than 1.5 times the external diameter of the solid bodies.

The propellant fluid can be a liquid or, preferably, a gas. The propellant gas is preferably nitrogen (N₂). The propellant fluid is introduced into the conduit system in order to convey the solid bodies through the conduit system by means of overpressure and negative pressure. The conduit system is in particular a piggable conduit system.

In a particularly preferred embodiment, the blocking device comprises multiple such main bodies, each having a continuous channel. In this case, the channels of all main bodies are advantageously passable for the solid bodies in the open position of the actuator and closed in the closed position. The blocking device is then thus preferably used for blocking multiple conduits. Multiple channels, each provided in one main body, for the solid bodies can also be closed or opened in a very simple manner by the displacement of the actuator, which preferably forms a blocking bar as mentioned above. The main bodies are preferably arranged in succession here and the actuator extends through all main bodies. The additional space requirement for further channels which are to be blocked by the blocking device is thus minimal.

If multiple main bodies are provided, the channels thereof advantageously extend in parallel to one another. If the main bodies are moreover all arranged in succession, the channels are then arranged in a common plane. Such an arrangement is not only particularly space-saving, but rather the channels can also be closed and opened for the solid bodies very easily by means of displacement of a single actuator, in particular each simultaneously closed and opened. The blocking device therefore preferably comprises multiple main bodies, but only a single actuator, which is used to close and open the channels of all main bodies.

The multiple main bodies are advantageously arranged clamped between two clamping elements in succession. End blocks or covers can be used as clamping elements, for example, which press from opposing sides against a row of main bodies arranged in between and are connected to one another by means of one or more connecting elements, such as connecting screws in particular. The clamping elements are preferably drawn toward one another by means of the connecting elements and thus clamp the main bodies arranged in between against one another. The clamping elements are thus used to hold together the main bodies and advantageously the blocking device as a whole. The connecting element or elements preferably extend through the main bodies.

The main body or bodies preferably each have a cuboid external form. If multiple main bodies are provided, they are preferably designed identically. The production is thus simplified. The blocking device can in particular be designed in such a way that the number of the main bodies is adaptable as needed. The blocking device can advantageously be disassembled nondestructively for this purpose, so that further main bodies can be added or ones already provided can be removed before the blocking device is subsequently reassembled. The blocking device thus preferably has a modular structure.

The at least one main body preferably comprises a passage opening intersecting, in particular intersecting at right angles, with the channel, through which the actuator extends displaceably. If multiple main bodies are provided, preferably all main bodies comprise such a passage opening intersecting with the channel. The actuator then advantageously extends through the passage openings of all main bodies, so that all channels can be closed or opened to the solid bodies by means of displacing the actuator.

The channel or channels are preferably passable to the propellant fluid in the closed position of the actuator, thus are only blocked for the solid bodies but not for the propellant fluid. For this purpose, the at least one main body and/or the actuator preferably comprises a groove, in particular a ring groove, to enable a passage for the propellant fluid even in the closed position. When the actuator extends through the at least one main body and a channel part is located in each case on both sides of the actuator in the closed position, the groove thus preferably extends from the first channel part to the second channel part. In this way, the channel is closed to the solid bodies by the actuator in the closed position but is still passable for the propellant fluid due to the groove. Of course, the blocking unit can also be designed in other embodiments in such a way that the channels of the main bodies are closed to both the solids and the propellant fluid in the closed position of the actuator.

In certain, also preferred embodiments, the at least one main body and/or the actuator can comprise a decelerating device for decelerating the solid bodies. For example, the actuator can comprise a further continuous or noncontinuous opening or recess in parallel to each of the continuous connecting channel or channels, which extends into the main body in parallel to the connecting channel and in which a spiral spring or another spring is inserted to decelerate the solid bodies in the closed position of the actuator. Alternatively or additionally to the spring, a damping element can also be provided to damp the deceleration of the solid bodies. The decelerating device can also be formed in that the above-mentioned grooves, in particular ring grooves, which are formed on the actuator in order to form a passage for the propellant fluid in the closed position are omitted or are only dimensioned small. During the approach of a solid body to the actuator located in the closed position, the propellant fluid then forms a cushion which decelerates the solid body. In order to transport the solid bodies away from the blocking device again with the aid of the propellant fluid, the actuator could be displaced back into the open position so that the propellant fluid can pass unobstructed through the actuator. The impact momentum of the solid body on the actuator decreases due to the deceleration, due to which the actuator and the solid bodies are worn less strongly.

A seal is advantageously provided to seal the at least one main body in relation to the actuator in such a way that gas cannot escape to the outside from the channel between the main body and the actuator in the open position or in the closed position. “Outside” means the surroundings outside the blocking device here.

If the blocking device comprises multiple main bodies, a seal element is preferably arranged in each case between adjacent main bodies in order to prevent gas from being able to escape to the outside between the main bodies in the open position or in the closed position. Here too, “outside” means the surroundings outside the blocking device.

The blocking device preferably comprises a stop surface which is used for stopping the actuator during the displacement into the open position, in order to thus define the open position. In that the actuator is therefore displaced until stopping on the stop surface during the displacement into the open position, it can be ensured in a simple manner that the actuator is positioned in the correct position for the release of the channels. In particular if the actuator comprises connecting channels, which are used in the open position to connect two oppositely arranged channel parts of the main bodies in each case, it can be ensured easily but nonetheless effectively with the aid of the stop surface that the open position is correctly assumed by the actuator and the channels and channel parts open and merge into one another as exactly as possible.

The blocking device advantageously also comprises a drive which is used to displace the actuator from the open position into the closed position and vice versa. The drive can in particular be an electric drive or a hydraulic drive. The drive can be a rotation drive or a linear drive. In one particularly preferred embodiment, the drive is a pneumatic drive, thus a drive which is based on compressed air or another gas, such as nitrogen in particular, as a working medium. The blocking device preferably comprises a drive piston attached to the actuator for this purpose, which is movable by means of gas pressure in two opposing directions. The blocking device preferably comprises a piston chamber, in which the drive piston is displaceably arranged.

The present invention moreover relates to the use of the blocking device, as was described above, as a stopping element for balls of an aeroball measurement system, which is used to measure the neutron flux distribution in a nuclear reactor. The blocking device can then also be designated as a ball stopper. The blocking device is advantageously used here to stop the balls in the parking position. The blocking device can in particular also be arranged between the parking position and a measuring point, in particular a measuring table, in order to stop the balls in the parking position and let them through to the measuring point as needed.

In addition, the present invention also relates to the use of the blocking device, as was described above, as a stopping element for targets of a nuclide activation system, which is used to irradiate the targets in a nuclear reactor. The blocking device can then also be designated as a target stopper or, in the case in which the targets are formed as balls, as a ball stopper. The blocking device is advantageously used here to stop the targets in the parking position. The blocking device can in particular also be arranged between the parking position and a removal point, where the sufficiently irradiated targets can be removed from the nuclide activation system, in order to stop the targets in the parking position and let them through as needed to the removal point. A fitting box can be arranged between the blocking device and the removal point, which is preferably used, depending on which conduits are connected, to pass on the targets to the removal point or to introduce or discharge propellant fluid into/out of the nuclide activation system.

However, other uses of the blocking device are also conceivable. The blocking device can thus also be used in other embodiments and with corresponding design, for example, as an emergency closing device. The emergency closing device can be used, for example, to disconnect a conduit system section close to the reactor from a conduit system section far away from the reactor upon occurrence of a leak in an instrumentation finger.

The blocking device is preferably arranged within a shield, which shields the radiation originating from the irradiated solid bodies to the outside.

### BRIEF DESCRIPTION OF THE DRAWINGS

Preferred embodiments of the invention are described hereinafter on the basis of the drawings, which are used solely for explanation and are not to be interpreted as restrictive. In the drawings:

FIG. 1 shows a functional diagram of a combined aeroball measurement system and a nuclide activation system in a nuclear power plant;

FIG. 2 shows a perspective view of a blocking device according to an embodiment according to the invention;

FIG. 3 shows another perspective view of the blocking device of FIG. 2;

FIG. 4 shows a central sectional view of the blocking device of FIG. 2, with the piston in the open position;

FIG. 5 shows a sectional view in plane V-V (see FIG. 4) of the blocking device of FIG. 2;

FIG. 6 shows a sectional view in plane VI-VI (see FIG. 4) of the blocking device of FIG. 2;

FIG. 7 shows a sectional view (only partially shown) in plane VII-VII (see FIG. 4) of the blocking device of FIG. 2;

FIG. 8 shows a sectional view in plane VIII-VIII (see FIG. 5) of the blocking device of FIG. 2;

FIG. 9 shows a detail view of the area IX marked in FIG. 4;

FIG. 10 shows a central sectional view of the blocking device of FIG. 2, with the piston in the closed position;

FIG. 11 shows a central sectional view of a blocking device according to another embodiment according to the invention, with the piston in the open position;

FIG. 12 shows a central sectional view of the blocking device of FIG. 11, with the piston in the closed position;

FIG. 13 shows a central sectional view in plane VIII-VIII (see FIG. 11) of the blocking device of FIG. 11;

FIG. 14 shows a central sectional view of a blocking device of FIG. 11, with a handle for manual operation; and

FIG. 15 shows a further functional diagram of a combined aeroball measurement system and a nuclide activation system in a nuclear power plant, with twofold use of the blocking device of FIG. 11.

### DESCRIPTION OF PREFERRED EMBODIMENTS

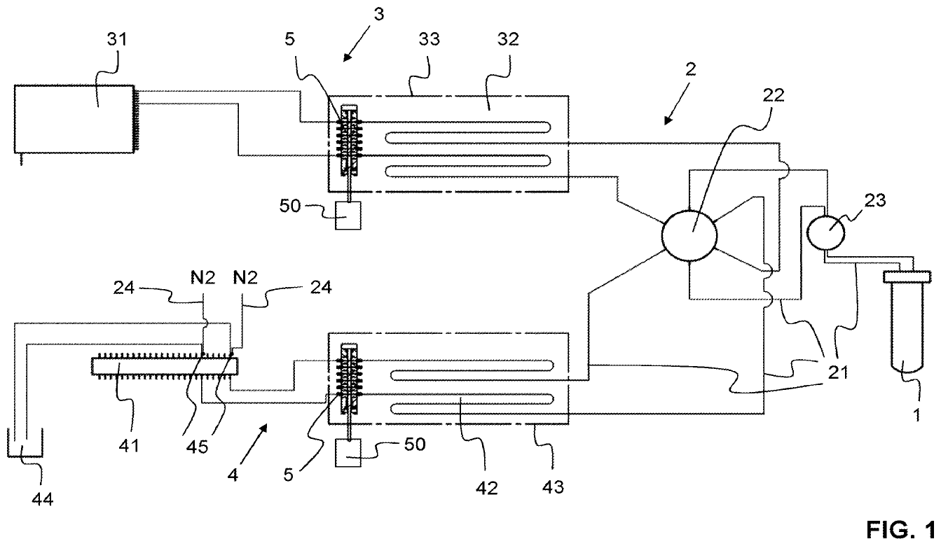

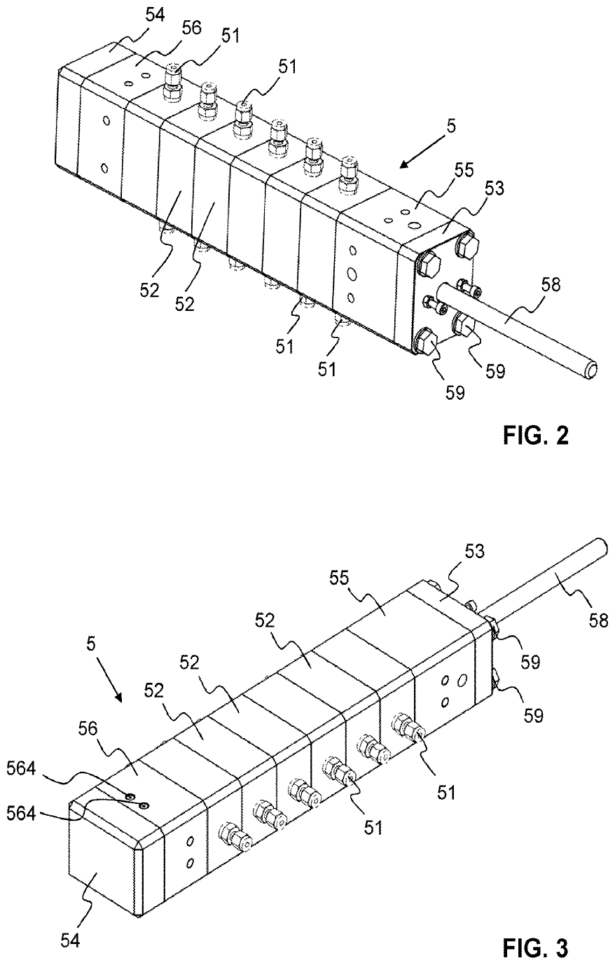

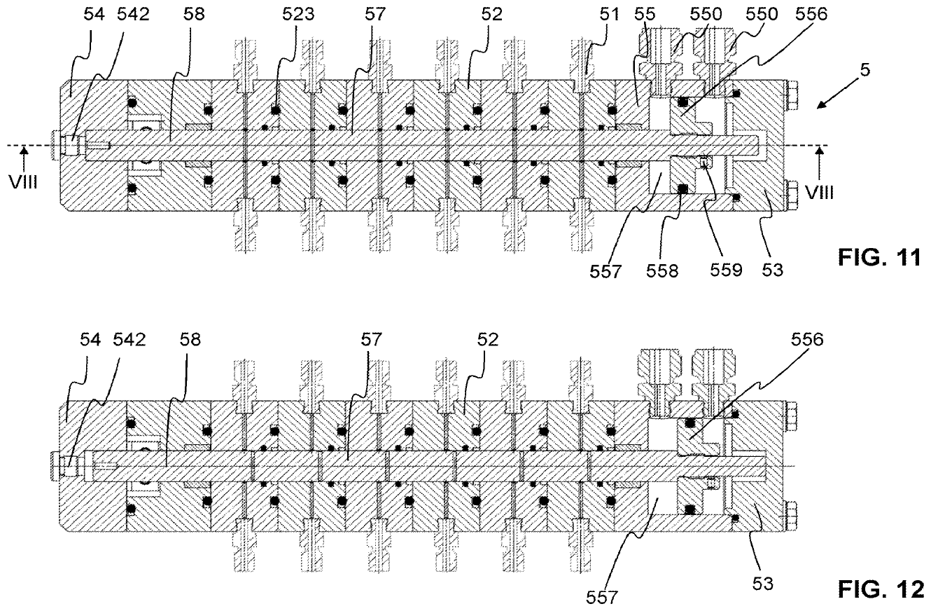

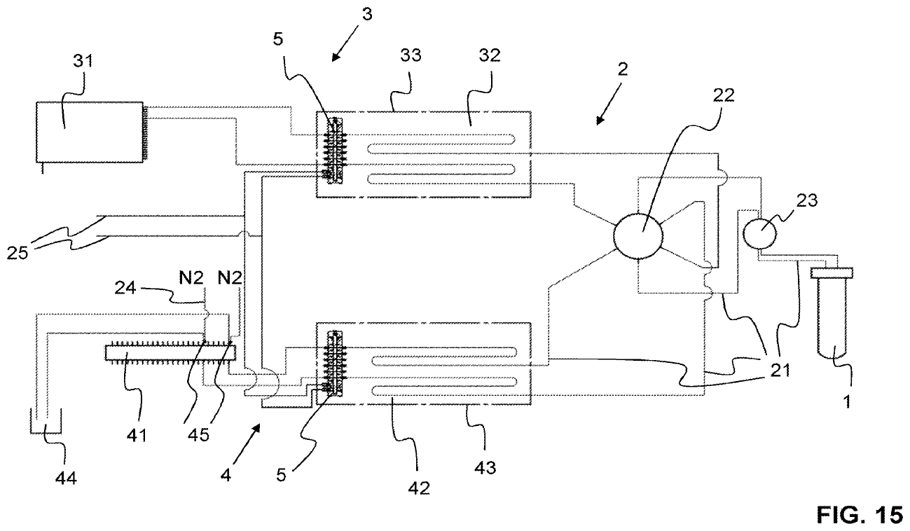

FIG. 1 shows a functional diagram of a nuclide activation system 4 combined with an aeroball measurement system 3, as is used, for example, in a nuclear power plant having a nuclear reactor 1. Two blocking devices 5 according to the invention are used here in an associated conduit system 2. An example of an embodiment of such a blocking device according to the invention is shown in more detail in FIGS. 2 to 10. A further example of an embodiment of a blocking device according to the invention is shown in FIGS. 11 to 14. FIG. 15 shows a functional diagram expanded in relation to FIG. 1, which is suitable in particular for the twofold use of a blocking device according to this further example. Functionally identical or similar features of different embodiments are each provided with the same reference signs in the drawings.

The conduit system 2 comprises a plurality of conduits 21, which as applicable represent a part of the aeroball measurement system 3 or the nuclide activation system 4 or belong to both systems. It is used to introduce measuring balls or nuclide activation targets into one or typically multiple instrumentation fingers of the nuclear reactor 1 and to transport them back out again after a sufficient dwell time. A propellant fluid, preferably a propellant gas, is used to transport the measuring balls or targets, that is to say the balls or targets are transported by means of overpressure and negative pressure through the conduit system 2. The use of nitrogen (N₂) is preferred as the propellant gas.

All components of the conduit system 2 and in particular the conduits 21 are dimensioned with respect to their internal diameters so that the balls or targets can be conveyed well by means of the propellant gas without being able to mutually change positions. The conduits 21 accordingly have a conduit internal diameter which approximately corresponds to the external diameter of the balls or targets. At most, the internal diameter of the conduits 21 is slightly larger, i.e., preferably by at most 10%, more preferably by at most 5%, than the external diameter of the balls and the targets. The balls and the targets preferably have approximately the same external diameter.

The aeroball measurement system 3 comprises a parking position 32, which is provided for parking the measuring balls when no measurement is carried out. The measuring balls are preferably arranged adjacent to one another in multiple parallel rows. Preferably, each row corresponds to precisely one instrumentation finger in the nuclear reactor 1, i.e., the arrangement of the measuring balls in the parking position 32 corresponds to the arrangement of the measuring balls in the nuclear reactor 1.

During their transport through the conduits 21 of the conduit system 2, the measuring balls receive a significant level of kinetic energy due to the drive by the propellant gas. This is therefore also referred to as a ball firing measuring system. To stop the balls returned from the nuclear reactor 1 upon reaching the parking position 32, a blocking device 5 is provided, which can also be designated as a ball stopper.

Since the measuring balls are typically still radioactive upon reaching the parking position 32, a shield 33 is provided which completely encloses the parking position 32 and the blocking device 5 in order to protect the surroundings from radioactive radiation.

The measuring balls are preferably vanadium-containing steel balls. A measuring table 31 having multiple radiation detectors is provided for measuring the activity of the balls irradiated in the nuclear reactor 1. The measuring balls are preferably arranged adjacent to one another in multiple parallel rows on the measuring table 31, analogously as in the parking position 32, wherein preferably each row corresponds to precisely one instrumentation finger in the nuclear reactor 1. The neutron flux at a corresponding point in the nuclear reactor 1 can thus be concluded in a simple manner from the measured radiation of each measuring ball.

Corresponding connecting conduits 21 are provided to convey the measuring balls from the parking position 32 to the measuring table 31 or in the reverse direction. The blocking unit comprises an actuator (explained in more detail hereinafter), using which the passages from the parking position 32 to the connecting conduits 21 and thus to the measuring table 31 can be released or blocked for the balls.

Similarly to the aeroball measurement system 3, the nuclide activation system 4 also comprises a parking position 42, which is provided for parking the nuclide activation targets.

The targets are preferably arranged adjacent to one another in multiple parallel rows here. Each row also preferably corresponds to precisely one instrumentation finger in the nuclear reactor 1 here, i.e., the arrangement of the targets in the parking position 32 corresponds to the arrangement of the measuring balls in the nuclear reactor 1. The parking position is in particular assumed in each case by the targets when a measurement has to be carried out by means of the ball shoot system 2.

Since the neutron flux is typically lower in the area of the ends of the instrumentation fingers, dummy targets can be used for this points, which are only used for the correct arrangement of the targets in the nuclear reactor 1, but are not provided for the subsequent, for example medical use.

A blocking device 5 is also provided here to stop the targets returned from the nuclear reactor 1 upon reaching the parking position 42.

Since the targets are typically strongly radioactive upon reaching the parking position 42, a shield 43 is provided which completely encloses the parking position 42 and the blocking device 5, in order to protect the surroundings from radioactive radiation.

In order to be able to remove the targets from the nuclide activation system 4 after sufficient irradiation, the parking position 42 is connectable to removal conduits, which open into a removal container 44, via corresponding connecting conduits 21 and a fitting box 41. In order to remove the targets from the nuclide activation system 4, the actuator of the blocking device 5 is displaced into the open position, so that the passage in the blocking device 5 is released and the targets can be transported to the removal container 44.

The fitting box 41 is used to introduce nitrogen, thus the propellant gas, into the nuclide activation system 4 via corresponding N₂ conduits 24. When the targets are to be removed from the nuclide activation system 4, the N₂ conduits 24 are decoupled, for example, by hand from the fitting box 41 and instead the removal conduits are coupled on. Corresponding quick-action couplings 45 are advantageously provided for this purpose. The targets can be transported from the parking position 42 into the removal container 44, for example, utilizing the gravitational force.

The measuring balls and the nuclide activation targets are distributed from the parking positions 32 and 42, respectively, into the various instrumentation fingers of the nuclear reactor 1 by means of one or more distributor shunts 22. By means of the distributor shunts 22, the conduits 21 leading to the parking positions 32 and 42 are connected to the conduits 21 which lead to the respective instrumentation fingers. The distributor shunt(s) 22 can be designed, for example, according to the specifications in DE 10 2017 125 606 A1.

In addition, an emergency closing device 23 is provided in the conduit system 1 in direct proximity to the nuclear reactor 1. The emergency closing device 23 is used, for example, upon the occurrence of a leak in one of the instrumentation fingers to disconnect the conduit system section close to the reactor from the conduit system section far from the reactor. The emergency closing device can be designed as a rotation valve, in particular as a ball valve. In principle, however, it is also conceivable to use a blocking device according to the invention as the emergency closing device 23.

One preferred embodiment of the blocking device 5 used in the ball measuring system 3 and in the nuclide activation system 4 will be explained in more detail hereinafter on the basis of FIGS. 2 to 10.

As is very apparent on the basis of FIGS. 2 to 4, for example, the blocking device 5 comprises multiple main bodies 52, precisely six here, which are arranged in succession. The main bodies 52 are all designed identically and are each cuboid as a whole.

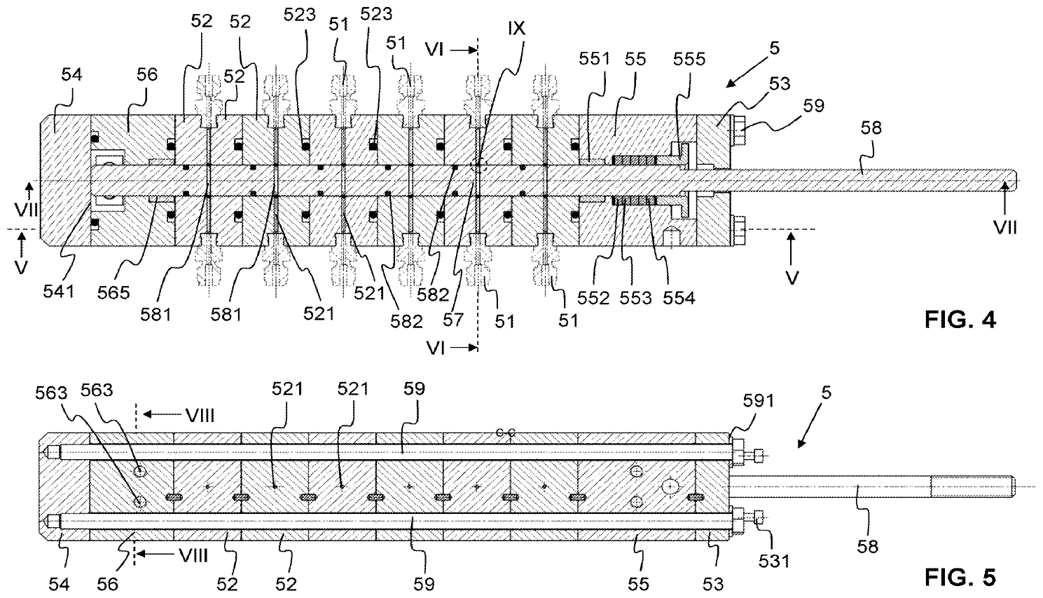

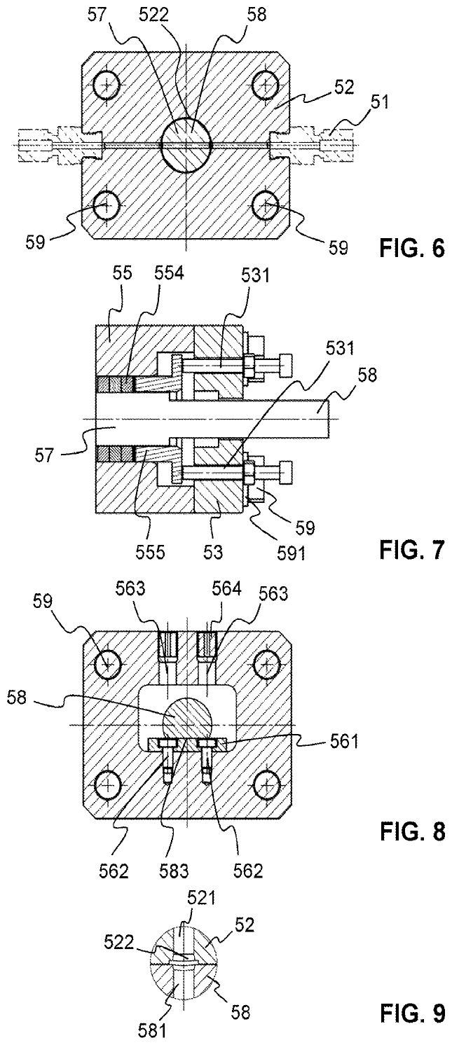

As can be inferred from FIGS. 4 and 6, a continuous channel 521, which is used for conducting through the measuring balls or targets, extends through each of the main bodies 52. The channels 521 of the different main bodies 52 all extend in parallel to one another. The internal diameter of the channels 521 preferably corresponds to that of the conduits 21, thus is approximately equal to or at most slightly larger than the external diameter of the measuring balls or targets. A conduit fitting 51, which is used to connect the channel 521 to a conduit 21, is provided in each case on both sides of the main bodies 52.

A guide block 55, 56 and then a cover 53, 54 is arranged at each of the ends of the row of the main bodies 52. The front cover 53 and the rear cover 54 are clamped by means of connecting screws 59 against the guide blocks 55, 56 and thus the main bodies 52. The row of the main bodies 52 is thus clamped like a sandwich between the guide blocks 55, 56, on the one hand, and the covers 53, 54. As is apparent in FIG. 5, the connecting screws 59, of which four are provided in the present exemplary embodiment, extend through the front cover 53, the guide blocks 55, 56, and the main bodies 52 and are screwed into the rear cover 54 by means of mutual thread engagement. The screw heads of the connecting screws 59 press against the front cover 53. A washer 591 is arranged between each of the screw heads and the cover 53.

A passage opening 57, which intersects perpendicularly with each of the channels 521 of the main bodies 52, extends through the front cover 53, the guide blocks 55, 56, and all main bodies 52. A piston rod 58, which forms an actuator of the blocking device 5 and is used to release or block the channels 521 of the main bodies 52, is inserted into the passage opening 57.

In the view of FIG. 4, the piston rod 58 is inserted completely into the passage opening 57, i.e., until stopping on a stop surface 541 of the rear cover 54. The piston rod 58 is located in this position in its open position, which is thus defined by the stop on the stop surface 541, and protrudes completely through all main bodies 52 and also the guide blocks 55, 56 and the front cover 53. The piston rod 58 has an external diameter in the interior of the main bodies 52 and the guide blocks 55, 56 which approximately corresponds to the internal diameter of the passage opening 57 or at most is slightly smaller.

Except for the protruding piston rod 58, the blocking device 5 as a whole has a compact cuboid shape. It is thus designed and installable in a space-saving manner.

The piston rod 58 comprises multiple channels 581, precisely six here, which each extend completely through the piston rod 58 perpendicularly to the longitudinal extension thereof. In the open position shown in FIG. 4, the channels 581 are in particular arranged so that they each represent an extension of the channels 521 of the main bodies 52 through the piston rod 58. The passage for the measuring balls or targets through the channels 521 is thus released via the channels 581.

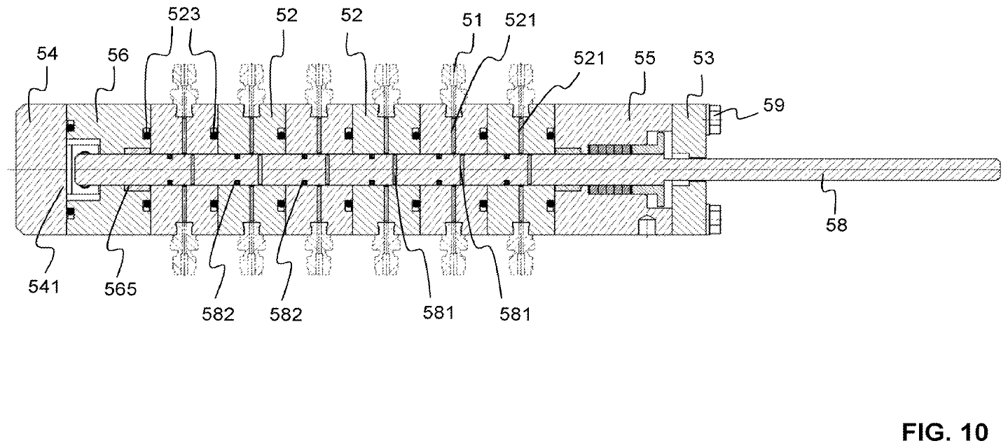

To move the piston rod 58 from the open position into the closed position, it is retracted somewhat by means of a drive 50 (see FIG. 1) from the stop surface 541. The closed position of the piston bar is shown in FIG. 10. The drive 50 can be, for example, an electric rotation or linear drive or a hydraulic drive. The drive 50 is connected to the piston rod 58 at that free end which protrudes outward from the front cover 53 (on the right side in each of the views of FIGS. 4 and 10).

As is clearly apparent in FIG. 10, the channels 581 of the piston rod 58 are arranged displaced in relation to the channels 521 of the main bodies 52 in the closed position. The passage for the measuring balls and the targets through the channels 521 of the main bodies 52 is thus blocked by the piston rod 58. As results from a consideration of FIGS. 4 and 10 together, a very small displacement is sufficient to move the piston rod 58 from the open position into the closed position and vice versa. The demands on the drive 50 are thus comparatively minor, so that its resulting dimensioning can also be smaller.

During displacement, the piston rod 58 is guided in guide bushings 551 and 565 of the guide blocks 55 and 56, respectively. As is apparent in FIG. 8, the piston rod 58 preferably has a lateral flattening 583 in the area of the rear guide block 56 and presses with this against a contact plate 561. The piston rod 58 is thus twist-locked. The contact plate 561 is fastened in a cavity of the guide block 56 by means of screws 562 on the guide block 56. The access to the screws 562 takes place via openings 563, which are provided on the opposite side of the cavity and are closable by means of closure plugs 564.

In the closed position of the piston rod 58, the channels 521 of the main bodies 52 are as mentioned closed to the measuring balls and the targets in the present embodiment. However, the channels 521 are not closed to the propellant gas in the open position or in the closed position. To enable an unobstructed passage of the propellant gas in the closed position as well, the main bodies 52 and/or the piston rod 58 each have a ring groove 522 in the areas of the channels 521 or 581, respectively, opening to the passage opening 57. The ring groove 522, which is apparent in particular in FIGS. 6 and 9, in each case extends starting from the channel openings in a ring shape around the piston rod 58 and thus ensures an unobstructed gas exchange between the two channel parts of the channels 521 arranged on both sides of the piston rod 58, even in the closed position.

To prevent an escape of propellant gas outward between the main bodies 52 and the piston rod 58, seal rings 582 are attached between each of the channels 581 on the piston rod 58. The seal rings 582 seal off the piston rod 58 in relation to the main bodies 52.

Further seals 523 are provided to seal off the main bodies 52 from one another and in relation to the guide blocks 55 and 56. The seals 523 thus prevent an escape of propellant gas outward between the main bodies 52 and the guide blocks 55, 56.

A further seal ring 552 is arranged in the front guide block 55 on the piston rod 58. It is used to seal off through the passage between the guide block 55 and the piston rod 58. The seal ring 552 can be pressed against the guide block 55 by means of a contact pressure sleeve 555 in the longitudinal direction of the piston rod 58 (see FIG. 7). The pressing force of the contact pressure sleeve 555 and thus the sealing action of the seal ring 552 can be set with the aid of two adjustment screws 531. In the present exemplary embodiment, a sliding plate 553 and an end ring 554 are arranged between the seal ring 552 and the contact pressure sleeve 555. The piston rod 58 extends through the seal ring 552, the sliding plate 553, the end ring 554, and the contact pressure sleeve 555.

A further exemplary embodiment of a blocking device 5 according to the invention is shown in FIGS. 11 to 14. In contrast to the exemplary embodiment of FIGS. 2 to 9, that of FIGS. 11 to 14 comprises an integrated pneumatic drive having a drive piston 556, which is attached by means of a threaded pin 559 or in another way on the piston rod 58 and is movable within a piston chamber 557. The piston chamber 557 is located in the interior of the guide block 55 and is delimited by the guide block 55 and the cover 53. On both sides of the drive piston 556, a gas fitting 550 opens into the piston chamber 557, to be able to introduce gas under pressure into the piston chamber 557 depending on the desired movement direction of the piston rod 58. The gas is thus used as a working medium to be able to move the piston rod 58 from the open position into the closed position and vice versa, wherein the gas can be compressed air, for example, but preferably nitrogen. The drive piston 556 is circumferentially sealed in relation to the inner wall of the guide block 55 by means of a piston seal 558.

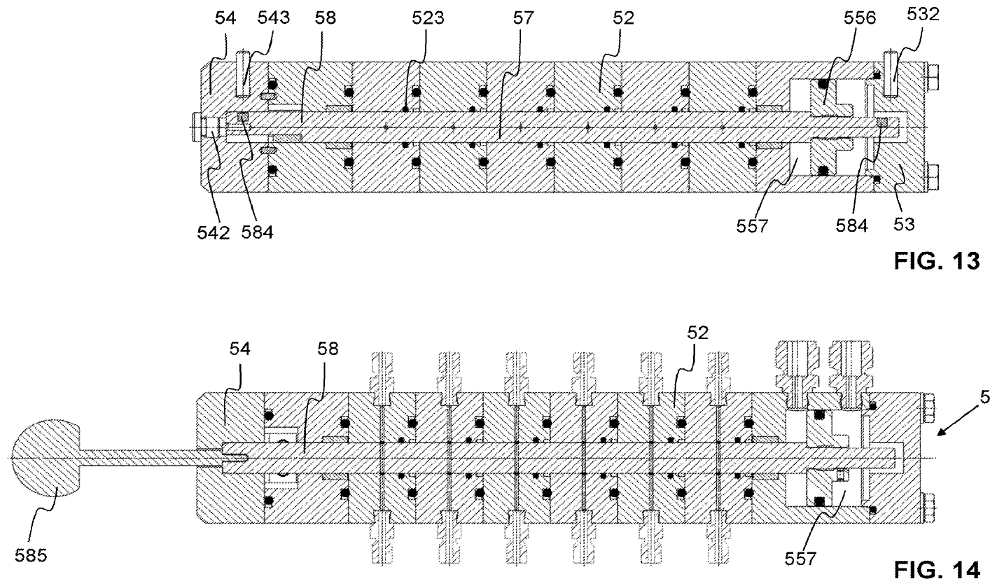

In the exemplary embodiment shown in FIGS. 11 to 14, two magnetic sensors 532, 543 are also provided, in order to measure the position of the piston rod 58, thus the actuator, in relation to the main bodies 52. A first magnetic sensor 532, as is apparent in FIG. 13, is positioned in a corresponding borehole of the cover 53 provided for this purpose and a second magnetic sensor 543 is positioned in a borehole of the cover 54 also provided for this purpose. To enable the measurement, a magnet 584, in particular a permanent magnet, is additionally attached in the area of each of the ends of the piston rod 58.

In contrast to the exemplary embodiment of FIGS. 2 to 9, that of FIGS. 11 to 14 moreover comprises a threaded borehole arranged centrally in the cover 54, which is closed using a closure screw 542 in normal operation. In case of an operational malfunction of the drive of the blocking device 5, the closure screw 542 can be unscrewed and a handle 585 can be screwed into a threaded borehole provided at the corresponding end of the piston rod 58. The piston rod 58 can then be temporarily displaced manually in emergency operation with the aid of the handle 585 from the open position into the closed position or vice versa.

A functional diagram, which is suitable in particular for the exemplary embodiment of the blocking device 5 of FIGS. 2 to 9, is shown in FIG. 15. The functional diagram of FIG. thus differs from that of FIG. 1 in that the two blocking devices 5 each correspond, on the one hand, to that which is shown in FIGS. 11 to 14 and, on the other hand, gas switching conduits 25 are provided, to control the pneumatic drives integrated in the blocking devices 5. One of the two gas fittings 550 of the first blocking device 5 is connected by means of a gas switching conduit 25 to one of the two gas fittings 550 of the second blocking device 5 in each case in such a way that an application of pressure of the corresponding gas switching conduit 25 results in closing of the first blocking device 5 and opening of the second blocking device 5 or vice versa.

Of course, the invention described here is not restricted to the mentioned embodiments and a large number of modifications are possible. The actuator, which is formed here by the piston rod 58, thus does not necessarily have to have a circular cross section as in the exemplary embodiment of FIGS. 2 to 10. The actuator could just as well have, for example, a rectangular, in particular square cross section. Moreover, the channels 521 do not necessarily all have to extend in parallel to one another, but could also extend in different directions. The channels 581 of the actuator would then have to be aligned accordingly. Instead of multiple, the blocking device could also only comprise a single main body, which has one or even multiple channels for the measuring balls or targets. An embodiment having multiple main bodies which each comprises multiple channels would also be conceivable. A large number of further modifications are conceivable.

LIST OF REFERENCE SIGNS

| | | | |
|---|---|---|---|
| 1 | nuclear reactor | 54 | cover |
| | | 541 | stop surface |
| 2 | conduit system | 542 | closure screw |
| 21 | conduit | 543 | magnetic sensor |
| 22 | distributor shunt | 55 | guide block |
| 23 | emergency closing device | 550 | gas fitting |
| 24 | N₂ conduits | 551 | guide bushing |
| 25 | gas switching conduits | 552 | seal ring |
| | | 553 | sliding plate |
| 3 | ball measuring system | 554 | end ring |
| 31 | measuring table | 555 | contact pressure sleeve |
| 32 | parking position | 556 | drive piston |
| 33 | shield | 557 | piston chamber |
| | | 558 | piston seal |
| 4 | nuclide activation system | 559 | threaded pin |
| 41 | fitting box | 56 | guide block |
| 42 | parking position | 561 | contact plate |
| 43 | shield | 562 | screw |
| 44 | removal container | 563 | opening |
| 45 | quick-action couplings | 564 | closure plug |
| | | 565 | guide bushing |
| 5 | blocking device | 57 | passage opening |
| 50 | drive | 58 | piston rod |
| 51 | conduit fitting | 581 | channel |
| 52 | main body | 582 | seal ring |
| 521 | channel | 583 | flattening |
| 522 | ring groove | 584 | magnet |
| 523 | seal | 585 | handle |
| 53 | cover | 59 | connecting screw |
| 531 | adjustment screw | 591 | washer |
| 532 | magnetic sensor | | |

1. A blocking device for stopping solid bodies which have been irradiated or are to be irradiated in a conduit system, which is used for transporting the solid bodies by means of a propellant fluid into and out of a nuclear reactor, comprising
at least one main body having a continuous channel for the solid bodies, and
an actuator arranged inside the main body, which is displaceable relative to the main body between an open position and a closed position in such a way that the channel is passable for the solid bodies in the open position and is closed in the closed position,
wherein the actuator can be moved by means of displacement relative to the at least one main body from the open position into the closed position and from the closed position into the open position.

2. The blocking device as claimed in claim 1, comprising multiple such main bodies each having a continuous channel, wherein the channels of all main bodies are passable for the solid bodies in the open position of the actuator and closed in the closed position.

3. The blocking device as claimed in claim 2, wherein the channels of all main bodies extend in parallel to one another.

4. The blocking device as claimed in claim 2, wherein the multiple main bodies are clamped arranged in succession between two clamping elements.

5. The blocking device as claimed in claim 1, to wherein the multiple main bodies are designed identically.

6. The blocking device as claimed in claim 1, wherein the at least one main body comprises a passage opening intersecting, in particular intersecting at right angles, with the channel, and wherein the actuator extends displaceably through the passage opening.

7. The blocking device as claimed in claim 1, wherein the main body and/or the actuator comprise a groove, in order to enable a passage for the propellant fluid also in the closed position.

8. The blocking device as claimed in claim 1, wherein a seal is provided to seal off the at least one main body from the actuator in such a way that gas cannot escape outward between the main body and the actuator out of the channel in the open position or in the closed position.

9. The blocking device as claimed in claim 1, comprising multiple main bodies, wherein a seal element is arranged in each case between adjacent main bodies to prevent gas from being able to escape outward between the main bodies in the open position or in the closed position.

10. The blocking device as claimed in claim 1, comprising a stop surface, which is used to stop the actuator during the displacement into the open position, in order to thus define the open position.

11. The blocking device as claimed in claim 1, additionally comprising a drive, which is used to displace the actuator from the open position into the closed position and vice versa.

12. A method to stop balls of an aeroball measurement system, which is used to measure the neutron flux distribution in a nuclear reactor, the method comprising at least the steps of
stopping the balls by means of a blocking device, which blocking device comprises at least one main body having a continuous channel for the balls and an actuator arranged inside the main body, which actuator is displaceable relative to the main body between an open position and a closed position in such a way that the channel is passable for the balls in the open position and is closed in the closed position; and
moving the actuator by means of displacement relative to the at least one main body from the open position into the closed position and/or from the closed position into the open position.

13. A method to stop targets of a nuclide activation system, which is used to irradiate the targets in a nuclear reactor, the method comprising at least the steps of
stopping the targets by means of a blocking device, which blocking device comprises at least one main body having a continuous channel for the targets and an actuator arranged inside the main body, which actuator is displaceable relative to the main body between an open position and a closed position in such a way that the channel is passable for the targets in the open position and is closed in the closed position; and
moving the actuator by means of displacement relative to the at least one main body from the open position into the closed position and/or from the closed position into the open position.

14. The blocking device as claimed in claim 1, wherein the conduit system forms a part of an aeroball measurement system.

15. The blocking device as claimed in claim 6, wherein the passage opening intersects at right angles with the channel.

16. The blocking device as claimed in claim 7, wherein the groove is a ring groove.

17. The blocking device as claimed in claim 11, wherein the drive is an electric or hydraulic drive.
